(19) United States
(12) Patent Application Publication
(10) Pub. No.: US 2019/0116601 A1
(43) Pub. Date: Apr. 18, 2019

(54) COMMUNICATION TERMINAL, COMMUNICATION METHOD, AND STORAGE MEDIUM IN WHICH COMMUNICATION PROGRAM IS STORED

(71) Applicant: NEC Corporation, Tokyo (JP)

(72) Inventor: Yoshitomo WARASHINA, Tokyo (JP)

(73) Assignee: NEC Corporation, Tokyo (JP)

(21) Appl. No.: 16/087,285

(22) PCT Filed: Mar. 15, 2017
(86) PCT No.: PCT/JP2017/010418

§ 371 Date: Sep. 21, 2018

(30) Foreign Application Priority Data
Mar. 25, 2016 (JP) 2016-062047

(51) Int. Cl. H04W 72/08; H04W 72/04; H04B 17/336; H04L 25/03

(52) U.S. Cl. CPC H04W 72/082; H04W 72/087; H04L 25/03821; H04B 17/336; H04W 72/0453

(57) ABSTRACT

[Problem] To provide a communication terminal, a communication method, and a communication program which enable maintenance of stable communication quality even if radio wave interference occurs between radio communication networks. [Solution] A radio wave environment recognition unit 11 recognizes a radio wave environment. A radio wave interference detection unit 12 detects radio wave interference between an associated radio communication network and another radio communication network. When the radio wave interference detection unit 12 detects the radio wave interference, an interference avoidance unit 13 executes interference avoidance processing for changing a channel to be used or integrating the associated radio communication network and the other radio communication network on the basis of the radio wave environment recognized by the radio wave environment recognition unit 11.

### TECHNICAL FIELD

The present invention relates to a communication terminal, a communication method, and a communication program capable of performing communication according to a radio wave environment.

### BACKGROUND ART

A frequency that is not used geographically or temporally by any wireless license holder (for example, a carrier frequency, hereinafter simply referred to as frequency) is called white space. Research on cognitive radio which temporarily utilizes such white space is being promoted in order to further improve the frequency utilization efficiency.

In cognitive wireless, a technique for dynamically allocating frequencies is required. In order to dynamically allocate frequencies, it has been proposed to, for example, use information about frequency usage by existing wireless communication systems (called a primary user) in the vicinity. In addition, a method using a database that has a function of calculating available frequency that can be used at each position and time has been proposed. Furthermore, a frequency selection method has been proposed in which a frequency is dynamically allocated to a wireless communication terminal (secondary user) by using a spectrum sensing function of a wireless communication terminal. Note that the frequency of the received signal and the frequency of the transmitted signal are also referred to as “channel”.

When a communication terminal having a communication function with cognitive wireless detects a signal transmitted by a primary user by performing spectrum sensing or detects that its own communication is being interfered by communication performed by another communication system, the communication terminal performs channel switching to avoid interference.

Further, in a mobile ad hoc network, there is a clustering technique as a technique for efficiently managing a large number of communication terminals. In such a clustering technique, in the adaptive clustering method, cluster reconfiguration is performed according to the movement of the communication terminal. And, there is a method for, when there are a plurality of clusters in which a number of communication terminals belonging thereto is equal to or less than a certain number, these clusters are combined.

In such a method, each of the clusters can select a channel to be used, and in the case where at least two geographically close clusters use the same channel, the clusters are combined to be managed by a single cluster head (management terminal). By doing so, interference between clusters can be avoided. In this way, combining a plurality of clusters (for example, wireless communication networks) to integrate communication terminal management may also be referred to as “network integration”.

PTL 1 describes a method in which occurrence of radio wave interference is monitored and, in the case where another wireless communication network is using one channel, network integration is performed, or the channel to be used is changed to another channel.

PTL 2 describes a method for allocating available channels to each wireless base station, based on the received field strengths measured by the wireless base station.

### CITATION LIST

### Patent Literature

[PTL 1] JP 10-51376 A

[PTL 2] JP 10-13924 A

### SUMMARY OF INVENTION

### Technical Problem

However, with the technique as described above, it is not considered to completely avoid the radio wave interference in a situation where the channel is insufficient for the scale of the wireless communication network. FIG. 10 is an explanatory diagram illustrating a plurality of wireless communication networks and channels used by each wireless communication network.

The example in FIG. 10 illustrates three wireless communication networks that can utilize two channels, i.e., a channel indicated as 1 ch and a channel indicated as 2 ch in FIG. 10. Then, it is assumed that each wireless communication network is in an overcrowded environment geographically overlapping each other. In such an environment, as illustrated in FIG. 10, radio wave interference cannot be avoided even when each wireless communication network respectively changes the channel.

Both of the method described in method PTL 1 and the method described in method PTL 2 are techniques for avoiding use of one channel where radio wave interference occurs, and both have similar problems.

FIG. 11 is an explanatory diagram illustrating an example of network integration. As illustrated in FIG. 11, the network integration technology as described above is a network integration technology in which an integrated wireless communication network utilizes one channel (single channel), thereby avoiding load concentration of the management terminal managing the wireless communication network. Therefore, even if there is another channel that can completely avoid radio wave interference, the another channel is not used, and as a result, resources allocated to each of the communication terminals of the wireless communication network are reduced.

Accordingly, it is an object of the present invention to provide a communication terminal, a communication method, and a communication program capable of maintaining stable communication quality even in the case where radio wave interference occurs between wireless communication networks.

### Solution to Problem

A communication terminal, according to the present invention, comprises:

radio wave environment recognition means recognizing radio wave environment;

radio wave interference detection means detecting radio wave interference between a wireless communication network to which the communication terminal belongs and another wireless communication network; and

interference avoidance means executing interference avoidance processing to change a channel to be used, or integrate the wireless communication network to which the communication terminal belongs with the another wireless communication network, based on the radio wave environment recognized by the radio wave environment recognition means, in a case where the radio wave interference detection means detects the radio wave interference.

A communication method, according to the present invention, comprises:

recognizing radio wave environment;

detecting radio wave interference between a wireless communication network to which the communication terminal belongs and another wireless communication network; and

executing interference avoidance processing to change a channel to be used, or integrate the wireless communication network to which the communication terminal belongs with the another wireless communication network, based on the recognized radio wave environment.

A communication program, according to the present invention, causing a computer to execute:

radio wave environment recognition processing for recognizing radio wave environment;

radio wave interference detection processing for detecting radio wave interference between a wireless communication network to which the communication terminal belongs and another wireless communication network; and

interference avoidance processing for executing interference avoidance processing to change a channel to be used, or integrate the wireless communication network to which the communication terminal belongs with the another wireless communication network, based on the radio wave environment recognized by the radio wave environment recognition processing, in a case where the radio wave interference detection processing detects the radio wave interference.

### Advantageous Effects of Invention

According to the present invention, stable communication quality can be maintained even in the case where radio wave interference occurs between wireless communication networks.

### BRIEF DESCRIPTION OF DRAWINGS

FIG. 1 is a block diagram illustrating a configuration example of a communication terminal of a first example embodiment of the present invention.

FIG. 2 is a flowchart illustrating operation of the communication terminal of the first example embodiment of the present invention.

FIG. 3 is a flowchart illustrating processing in step S105 by the interference avoidance method determination unit.

FIG. 4 is a block diagram illustrating a configuration example of a communication terminal of a second example embodiment of the present invention.

FIG. 5 is a flowchart illustrating operation of the communication terminal of the second example embodiment of the present invention.

FIG. 6 is a flowchart illustrating processing in step S306 by an interference avoidance method determination unit of the second example embodiment.

FIG. 7 is an explanatory diagram illustrating operation environment example of each wireless communication network.

FIG. 8 is an explanatory diagram illustrating an example of an estimation result of communication quality of each wireless communication network according to the interference avoidance processing of each pattern.

FIG. 9 is a block diagram illustrating a configuration example of a communication terminal of a third example embodiment of the present invention.

FIG. 10 is an explanatory diagram illustrating a plurality of wireless communication networks and channels used by wireless communication networks.

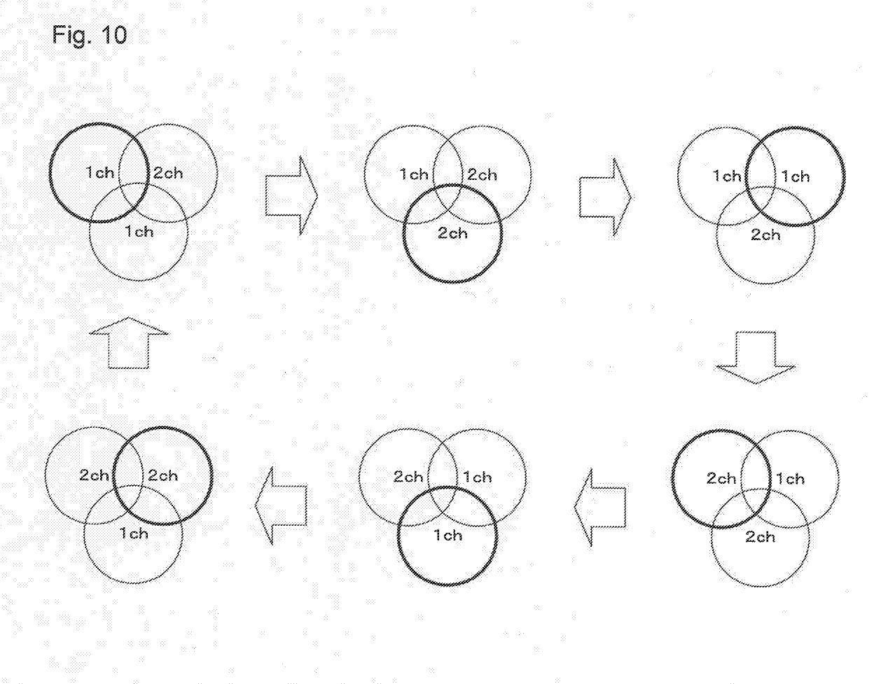

FIG. 11 is an explanatory diagram illustrating an example of network integration.

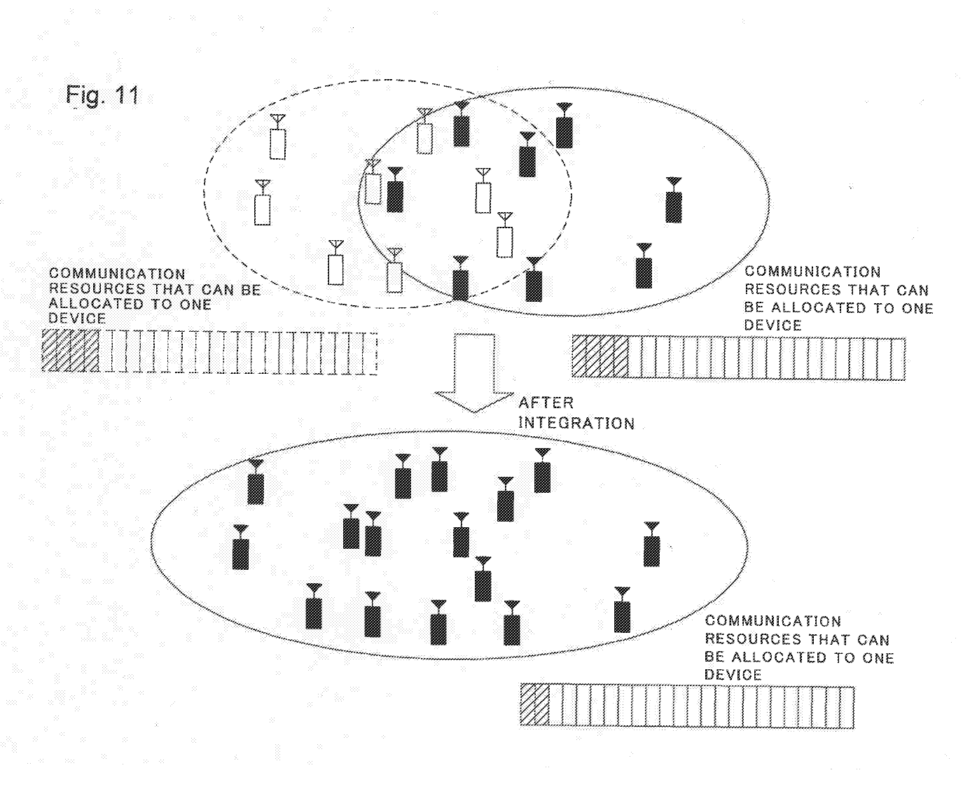

### EXAMPLE EMBODIMENT

### First Example Embodiment

A communication terminal 100 of the first example embodiment of the present invention is described. The communication terminal 100 of the first example embodiment of the present invention has a function capable of communication via one wireless communication network and communication via another wireless communication network that can be integrated with the one wireless communication network.

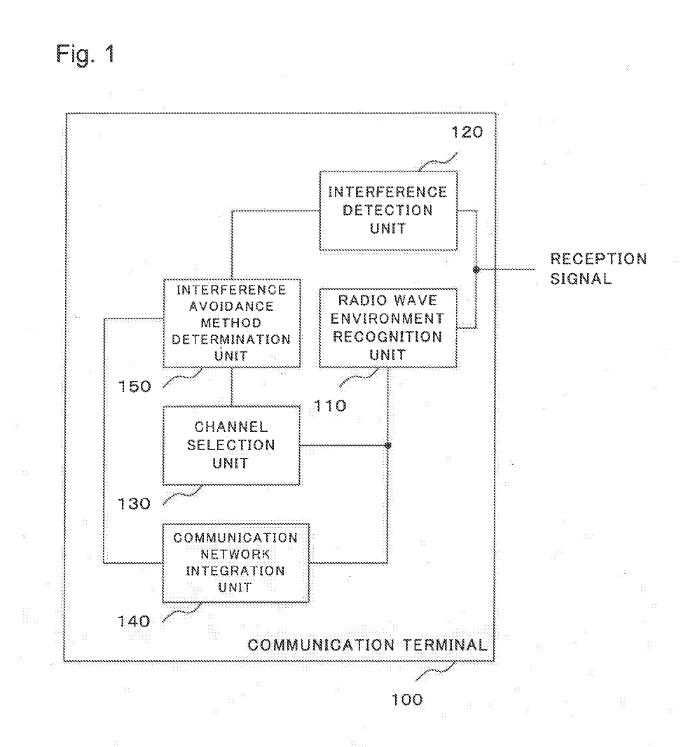

FIG. 1 is a block diagram illustrating the configuration example of the communication terminal 100 of the first example embodiment of the present invention. As illustrated in FIG. 1, the communication terminal 100 of the first example embodiment of the present invention includes a radio wave environment recognition unit 110, an interference detection unit 120, a channel selection unit 130, a communication network integration unit 140, and an interference avoidance method determination unit 150.

Radio wave environment recognition unit 110 and interference detection unit 120 receives a signal, based on a radio wave via an antenna (not illustrated).

Then, based on the strength of the received signal and data obtained by demodulating and decoding the signal by a signal processing unit (not illustrated), the radio wave environment recognition unit 110 performs radio wave environment recognition processing to acquire radio wave environment corresponding to the number and position of the other communication terminals, the moving speed, channel occupancy rate, communication quantity, and the like. Then, the radio wave environment recognition unit 110 inputs information corresponding to the acquired radio wave environment to the channel selection unit 130 and communication network integration unit 140.

Note that the radio wave environment recognition unit 110 is configured to acquire information corresponding to the radio wave environment by other methods such as spectrum sensing, information sharing between communication terminals, access to a database, and the like.

The interference detection unit 120 performs interference detection processing to determine whether the received signal is an interference signal that is a signal transmitted by a communication terminal communicating via another wireless communication network other than the one wireless communication network that is communicating. Then, in the case where the interference detection unit 120 determines that the signal is an interference signal, the interference detection unit 120 notifies the interference avoidance method determination unit 150 to that effect and prompts execution of interference avoidance processing.

Note that the criterion, based on which the interference detection unit 120 determines whether or not the received signal is an interference signal may be a criterion as to whether demodulation or decoding on the received signal strength is possible or not, or may be an ID (IDentifier) or the like for identifying the communication terminal of the sender of the signal indicated by the data obtained by demodulating and decoding the signal, or other determination criteria.

The channel selection unit 130 identifies an available channel, based on information corresponding to the radio wave environment input by the radio wave environment recognition unit 110, and notifies the interference avoidance method determination unit 150 of the identification result. In addition, the channel selection unit 130 selects a channel to be used for communication in response to a request from the interference avoidance method determination unit 150.

Note that an available channel is, for example, a channel that is used by another wireless communication network but does not affect interference in each communication even if the wireless communication network to which the communication terminal 100 belongs is newly used, or a channel that is estimated, or a channel that is estimated to cause minimum interference with the other wireless communication network in the case where a communication means (not illustrated) uses among all available channels, or a channel whose channel occupancy rate by other wireless communication network is smaller than a predetermined value.

The communication network integration unit 140 identifies another integration-capable wireless communication network, based on the information corresponding to the radio wave environment input by the radio wave environment recognition unit 110 and notifies the interference avoidance method determination unit 150 of the identification result. In response to the request from the interference avoidance method determination unit 150, the communication network integration unit 140 requests integration to the wireless communication network determined to be most appropriate. Further, the communication network integration unit 140 determines whether or not to integrate the wireless communication network in the case where the integration is requested from another wireless communication network, and notifies the determination result to the another wireless communication network.

Note that an integration-capable wireless communication network means another wireless communication network to which as many communication terminals belonging thereto as the number of communication terminals that can be managed by one management terminal in the case where the another wireless communication network is integrated with the wireless communication network in question. In addition, the integration-capable wireless communication network means, in the case of a wireless communication network that performs multi-hop, another wireless communication network that can be configured so that the number of hops does not exceed a predetermined limitation number when the another wireless communication network is integrated with the wireless communication network in question.

In accordance with the request of the interference detection unit 120, the interference avoidance method determination unit 150 selects whether to execute either the channel selection or the network integration, based on the information input by the channel selection unit 130 and the information input by the communication network integration unit 140. Then, according to the determination result, the interference avoidance method determination unit 150 notifies the channel selection unit 130 or the communication network integration unit 140 to that effect.

Note that although the interference avoidance method determination unit 150 may determine to execute the channel selection when there is an available channel, the interference avoidance method determination unit 150 may be configured to make a determination to perform network integration, even when there is an available channel, according to the radio wave environment due to other wireless communication networks in proximity.

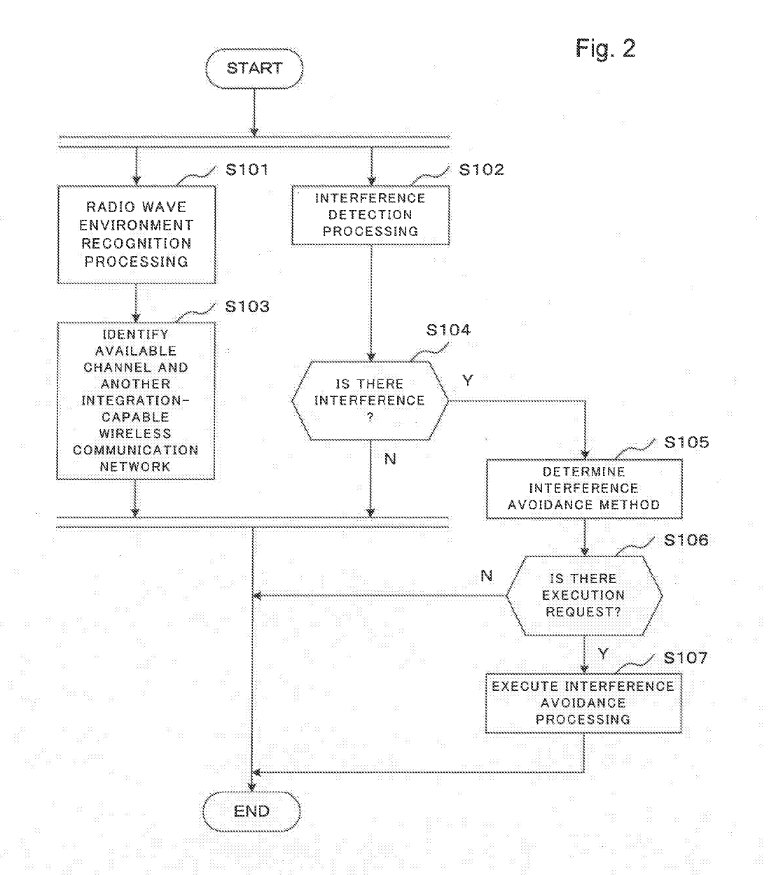

Next, the operation of the communication terminal 100 of the first example embodiment of the present invention will be described. FIG. 2 is a flowchart illustrating operation of the communication terminal 100 of the first example embodiment of the present invention. As illustrated in FIG. 2, the communication terminal 100 concurrently performs radio wave environment recognition processing (step S101) and interference detection processing (step S102). Specifically, the radio wave environment recognition unit 110 performs radio wave environment recognition processing (step S101), and the interference detection unit 120 performs interference detection processing (step S102).

The communication terminal 100 acquires information corresponding to the radio wave environment in the radio wave environment recognition processing in step S101. Then, based on the information corresponding to the acquired radio wave environment, the communication terminal 100 identifies the available channel and the another integration-capable wireless communication network (step S103).

Specifically, the radio wave environment recognition unit 110 acquires information corresponding to the radio wave environment in the radio wave environment recognition processing in step S101. Then, the radio wave environment recognition unit 110 inputs information corresponding to the radio wave environment acquired in the radio wave environment recognition processing in step S101 to the channel selection unit 130 and communication network integration unit 140. Then, in the processing of step S103, the channel selection unit 130 identifies available channels, based on the information corresponding to the radio wave environment input by the radio wave environment recognition unit 110, and notifies the identification result to the interference avoidance method determination unit 150. Also, in the processing of step S103, the communication network integration unit 140 identifies another integration-capable wireless communication network, based on the information corresponding to the radio wave environment input by the radio wave environment recognition unit 110, and notifies the interference avoidance method determination unit 150 of the identification result.

Also, in the case where the interference detection unit 120 determines that the signal received in the interference detection processing of step S102 is the interference signal (Y in step S104), the interference detection unit 120 notifies the interference avoidance method determination unit 150 to that effect and prompts the interference avoidance method determination unit 150 to execute the interference avoidance processing. In response to the notification by the interference detection unit 120, based on the information input by the channel selection unit 130 and the information input by the communication network integration unit 140, the interference avoidance method determination unit 150 determines whether to execute either the channel selection or the network integration (step S105). The processing in step S105 will be described later.

And, in response to the request from the interference avoidance method determination unit 150 (Y in step S106), the channel selection unit 130 or the communication network integration unit 140 executes channel selection or network integration (step S107).

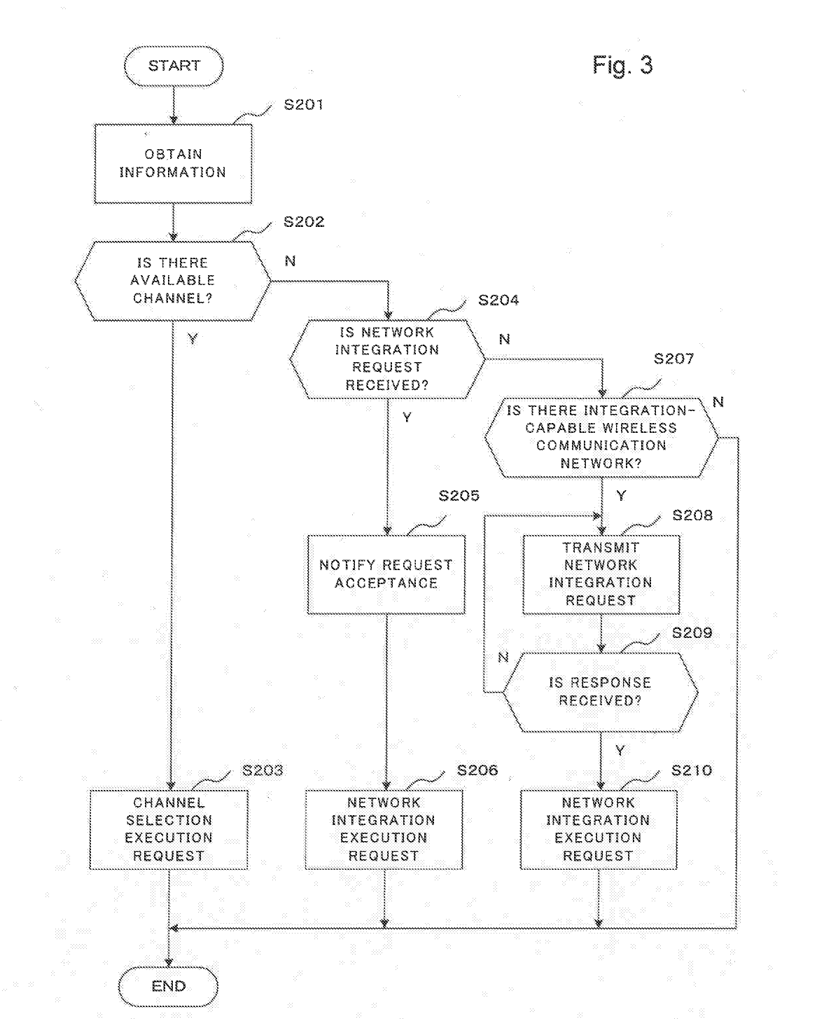

Next, the processing in step S105 by the above interference avoidance method determination unit 150 will be described in more detail. FIG. 3 is a flowchart illustrating the processing of step S105 by the interference avoidance method determination unit 150.

In the processing of step S105, first, the interference avoidance method determination unit 150 acquires information input by the channel selection unit 130 and information input by the communication network integration unit 140 (step S201).

Then, the interference avoidance method determination unit 150 determines whether there is any available channel, based on the information input by the channel selection unit 130 obtained in the processing of step S201 (step S202). In the case where it is determined that there is an available channel in the processing at step S202 (Y in step S202), the interference avoidance method determination unit 150 determines that channel selection is to be executed and requests the channel selection unit 130 to execute the channel selection (step S203). Then, the channel selection unit 130 executes channel selection in the processing of the above-described step S107 to avoid interference.

Also, in the case where it is determined that there is no available channel in processing at step S202 (N in step S202), the interference avoidance method determination unit 150 checks whether or not a network integration request has been received from another wireless communication network (step S204).

When it is confirmed that the network integration request has been received from another wireless communication network at processing of step S204 (Y in step S204), the interference avoidance method determination unit 150 notifies, to the wireless communication network of the sender which has sent the network integration request, that the request has been accepted (step S205). Then, the interference avoidance method determination unit 150 requests the communication network integration unit 140 to execute integration processing with the wireless communication network of the sender of the network integration request (step S206). Then, the communication network integration unit 140 executes integration processing with the wireless communication network of the sender of the network integration request in the processing of the above-described step S107 to avoid interference.

When it is confirmed that the network integration request has not been received from another wireless communication network at the processing of step S204 (N in step S204), the interference avoidance method determination unit 150 determines whether or not there is an integration-capable wireless communication network (step S207).

In the case where it is confirmed in the processing of step S207 that there is an integration-capable wireless communication network (Y in step S207), the interference avoidance method determination unit 150 proceeds to processing of step S208, and otherwise (N in step S207), the interference avoidance method determination unit 150 ends the processing in step S105.

In the processing of step S208, the interference avoidance method determination unit 150 transmits, to the integration-capable wireless communication network, a network integration request for requesting the integration of the wireless communication network (step S208).

And, in the case where the interference avoidance method determination unit 150 receives the response to the network integration request transmitted in the processing of step S208 (Y in step S209), the interference avoidance method determination unit 150 requests the communication network integration unit 140 to execute integration processing with the wireless communication network of the sender which sent the response (step S210).

Note that in the case where the interference avoidance method determination unit 150 does not receive a response even after a predetermined period of time has elapsed since sending the network integration request in the processing of step S208, the interference avoidance method determination unit 150 retransmits the network integration request.

Also, in the example illustrated in FIG. 3, processing is performed in the order of N in step S202, N in S204, and S207 to be configured to be prioritized in the order of channel selection, integration in response to request from another wireless communication network, and integration request to another wireless communication network, but the processing may be configured in other orders. Specifically, in precedence to the channel selection, at least one of or both of the integration in response to request from another wireless communication network and the integration request to another wireless communication network may be configured to be performed. Alternatively, in precedence to the integration in response to request from another wireless communication network, the integration request to another wireless communication network may be configured to be performed.

According to the present example embodiment, in the case where interference with another wireless communication network occurs, the interference detection unit 120 detects that the interference is occurring. Then, according to the radio wave environment recognized by the radio wave environment recognition unit 110 and the situation of another wireless communication network, the interference avoidance method determination unit 150 determines to execute either the channel selection or the network integration as the interference avoidance processing. Then, according to the determination result, the channel selection unit 130 performs the interference avoidance processing selects a channel, and the communication network integration unit 140 integrates the wireless communication network, so that the interference avoidance processing is performed. Therefore, high communication quality can be continuously obtained. Note that communication quality is, for example, quality of service (QoS) including throughput per communication terminal, communication disruption time, fairness with another wireless communication network, and quality of experience (QoE).

Also, according to the present example embodiment, for example, when there is a channel in which the value of the occupancy rate by another wireless communication network is smaller than a predetermined value, that is, a channel in which the wireless communication network to which the wireless communication network in question belongs can use a lot of communication resources, the channel selection unit 130 selects that channel. Also, when there is no such channel, the communication network integration unit 140 performs integration processing with an appropriate another wireless communication network to unify management of communication resources and share communication resources with the another wireless communication network, so that interference can be avoided.

Therefore, the interference avoidance method is appropriately determined according to the usage situation of each wireless communication network, so that high communication quality and stability can be obtained.

### Second Example Embodiment

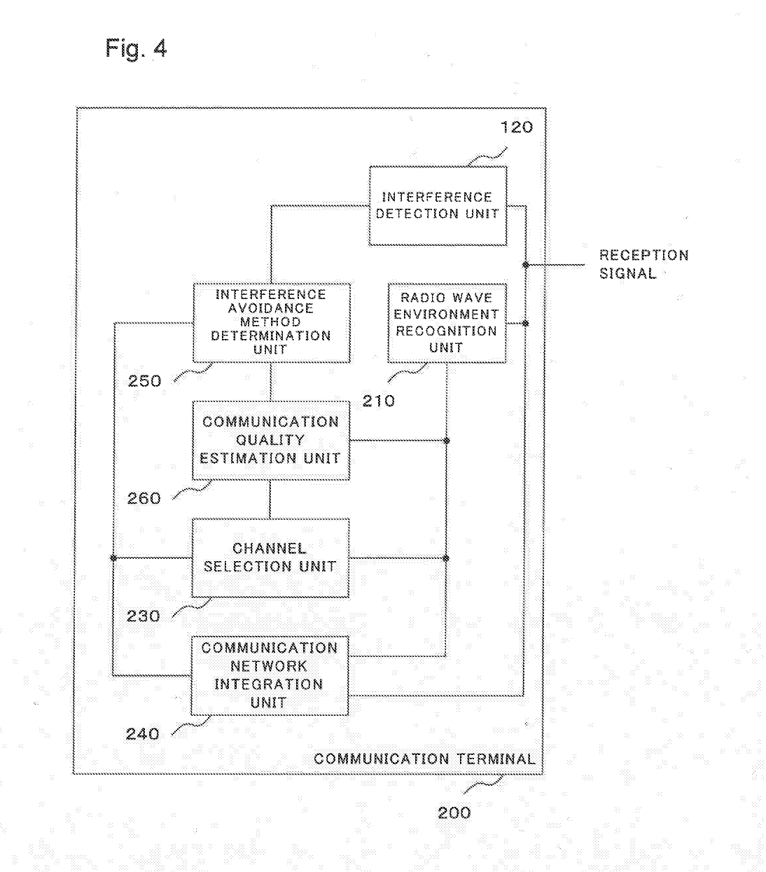

Next, a communication terminal 200 of the second example embodiment of the present invention will be described with reference to the drawings. FIG. 4 is a block diagram illustrating a configuration example of the communication terminal 200 of the second example embodiment of the present invention.

The communication terminal 200 of the second example embodiment of the present invention differs from the communication terminal 100 of the first example embodiment of the present invention illustrated in FIG. 1 in that the communication terminal 200 of the second example embodiment of the present invention includes a communication quality estimation unit 260.

Since the interference detection unit 120 is similar to the interference detection unit 120 of the first example embodiment of the present invention illustrated in FIG. 1, the same reference numerals as those in FIG. 1 are given so that the explanation thereabout is omitted.

The radio wave environment recognition unit 210 is different from the radio wave environment recognition unit 110 in the first example embodiment illustrated in FIG. 1 in that information corresponding to the acquired radio wave environment is input to the channel selection unit 230, the communication network integration unit 240, and the communication quality estimation unit 260.

The channel selection unit 230 notifies a channel, which is determined to be available, to not only the operation of the channel selection unit 130 of the first example embodiment but also the communication quality estimation unit 260.

The communication network integration unit 240 notifies the wireless communication network, which is determined to be able to be integrated, to not only the operation of the communication network integration unit 140 of the first example embodiment but also the communication quality estimation unit 260.

Based on information obtained from the radio wave environment recognition unit 210, the channel selection unit 130, and the communication network integration unit 240, the communication quality estimation unit 260 performs estimation processing of the communication quality to perform, in multiple patterns, an estimation of the communication quality in the case where the wireless communication network in question and the surrounding wireless communication network respectively use available channels and an estimation of communication quality obtained in the case where the wireless communication network in question is integrated with the integration-capable wireless communication network. Then, the communication quality estimation unit 260 notifies, to the interference avoidance method determination unit 250, the pattern corresponding to the estimation result that matches the condition designated by the user.

Here, the communication quality is estimated using known techniques, based on resource quantity (bandwidth, the number of frames, the number of time slots, and the like) available in each channel, the length of time the same channel can be continuously used, the application software used by the communication terminal belonging to the wireless communication network and the like, and the estimation method is not particularly limited.

The condition designated by the user is, for example, a condition in which the transmission rate per communication terminal belonging to the wireless communication network is set to 2 Mbps or more, when, in the case where video data is transmitted in real time via the wireless communication network, the minimum transmission rate necessary for smooth reproduction of video, based on the video data is 2 Mbps (bits per second).

Also, in the case of a communication network that is responsible for the command system of the wireless communication system, the user can designate, as the condition of the highest priority, that the stability is the highest, and more specifically, the sound quality is high, the picture quality is high, and no disruption of communication occurs. In addition, in the case of a wireless communication network with many movements, the user can designate the time length at which the interference avoidance action is not required even though the transmission rate is low. In addition, in the case of a wireless communication network with many movements, the user can designate, as the condition, the time length in which the interference avoidance action is not required even though the transmission rate is low.

The interference avoidance method determination unit 250 determines how to execute the channel selection and the network integration, based on the pattern notified by the communication quality estimation unit 260 in response to the execution request by the interference detection unit 120. And, in the case where it is determined that the channel selection is to be executed, the interference avoidance method determination unit 250 notifies, to the channel selection unit 230, a notification of the change-destination channel and the execution request. In addition, in the case where it is determined that the network integration is to be executed, the interference avoidance method determination unit 250 notifies, to communication network integration unit 240, a notification of the wireless communication network of the integration destination and the execution request.

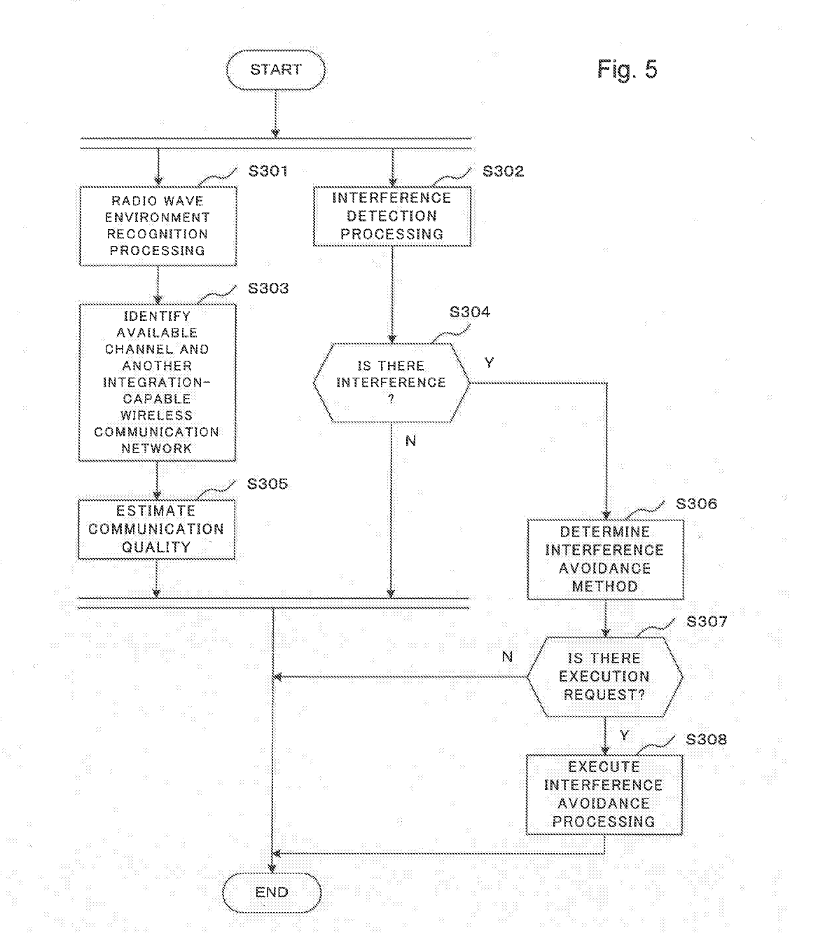

Next, the operation of the communication terminal 200 of the second example embodiment of the present invention will be described. FIG. 5 is a flowchart illustrating the operation of the communication terminal 200 of the second example embodiment of the present invention.

The processing of steps S301 to S304 illustrated in FIG. 5 performed by the communication terminal 200 is similar to the processing of the steps S101 to S104 executed by the communication terminal 100 in the first example embodiment, so that the explanation thereabout will be omitted.

Note that in the present example embodiment, in the process of step S303, the radio wave environment recognition unit 210 identifies an available channel and another integration-capable wireless communication network, and thereafter, in the processing of step S305, the communication quality estimation unit 260 performs the estimation processing of the communication quality (step S305).

Then, in the case where the interference detection unit 120 determines that the signal is an interference signal (Y in step S304) received in the interference detection processing in step S302, the interference detection unit 120 notifies the interference avoidance method determination unit 250 to that effect to urge the execution of the interference avoidance processing. According to the notification by the interference detection unit 120, the interference avoidance method determination unit 250 determines whether to execute either the channel selection or the network integration, based on the information input by the channel selection unit 230 and the information input by the communication network integration unit 240 (step S306). Note that the processing of S306 will be described later.

Then, the channel selection unit 230 or the communication network integration unit 240 executes the channel selection or the network integration (Y in step S307) according to the request of the interference avoidance method determination unit 250 (step S308).

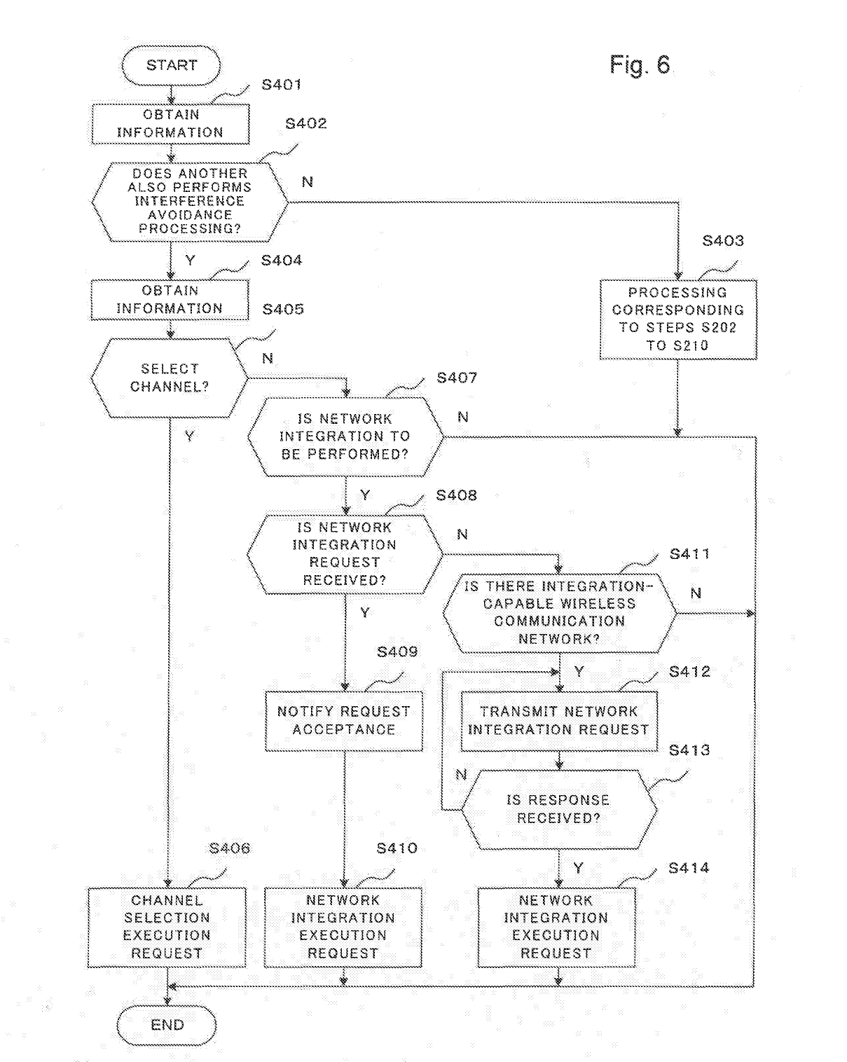

Next, the processing in step S306 by the interference avoidance method determination unit 250 will be described in more detail. FIG. 6 is a flowchart illustrating the processing of step S306 by the interference avoidance method determination unit 250 of the second example embodiment.

In the processing of step S306, the communication terminal 200 of the second example embodiment performs processing in view of another wireless communication network in proximity perform similar interference avoidance processing

More specifically, in the communication terminal 200 of the second example embodiment, first, the interference avoidance method determination unit 250 acquires information on the wireless communication network in proximity from the communication quality estimation unit 260 (S401), and checks whether there is another communication network that has a possibility of performing interference avoidance processing (step S402).

In the case where the interference avoidance method determination unit 250 determines that there is no other wireless communication network that has a possibility of performing the interference avoidance processing (N in step S402), the interference avoidance method determination unit 250 proceeds to the processing in step S202 in the first example embodiment illustrated in FIG. 3, and performs processing equivalent to processing in steps S202 to S210 (step S403).

In the case where the interference avoidance method determination unit 250 determines that there is another wireless communication network performing interference avoidance processing (Y in step S402), the communication quality estimation unit 260 performs estimation processing of the communication quality estimating the communication quality when performing the interference avoidance processing for each of the other wireless communication networks. Then, the communication quality estimation unit 260 notifies the result of the estimation processing of the communication quality to the interference avoidance method determination unit 250. The interference avoidance method determination unit 250 acquires the notification result of the communication quality estimation processing (step S404).

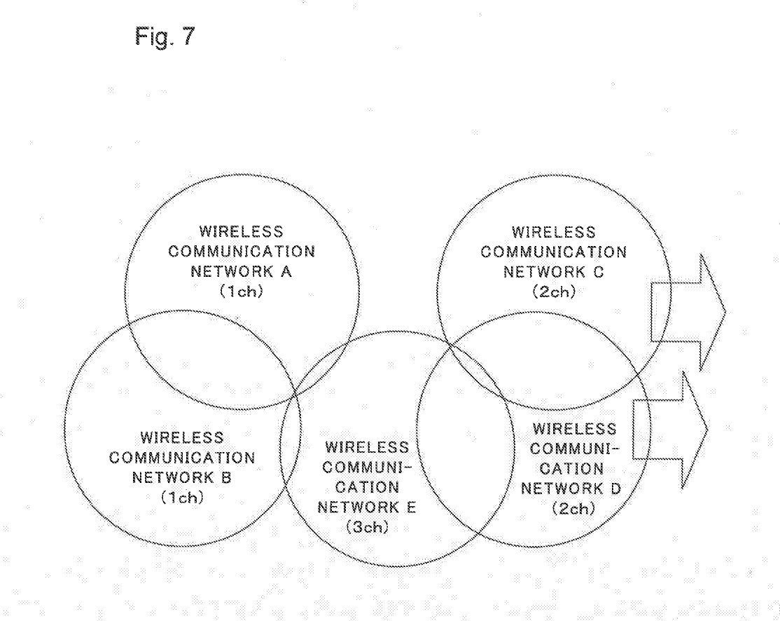

FIG. 7 is an explanatory diagram illustrating operation environment example of each wireless communication network. In this example, it is assumed that, in the wireless communication networks, the available channels are the first channel (also referred to as 1 ch), the second channel (also referred to as 2 ch), and the third channel (also referred to as 3 ch). FIG. 7 indicates that, in a wireless communication network A (also simply referred to A), 1 ch is used to perform communication. Also, FIG. 7 indicates that, in a wireless communication network B (also simply referred to B), 1 ch is used to perform communication. Further, FIG. 7 indicates that, in a wireless communication network C (also simply referred to C), 2 ch is used to perform communication.

FIG. 7 indicates that, in a wireless communication network D (also simply referred to D), 2 ch is used to perform communication. Also, FIG. 7 indicates that, in a wireless communication network E (also simply referred to E), 3 ch is used to perform communication.

Then, in this example, the wireless communication network A and the wireless communication network B interfere with each other in 1 ch. Also, in this example, the wireless communication network C and the wireless communication network D interfere with each other in 2 ch. In this example, the wireless communication network E uses 3 ch exclusively.

In such a situation, the communication quality estimation unit 260 performs the estimation processing of the communication quality estimating the communication quality in a predetermined period when performing the interference avoidance processing for each wireless communication network A to E. Note that the communication quality in the predetermined period is indicated by, for example, a throughput value of a predetermined period.

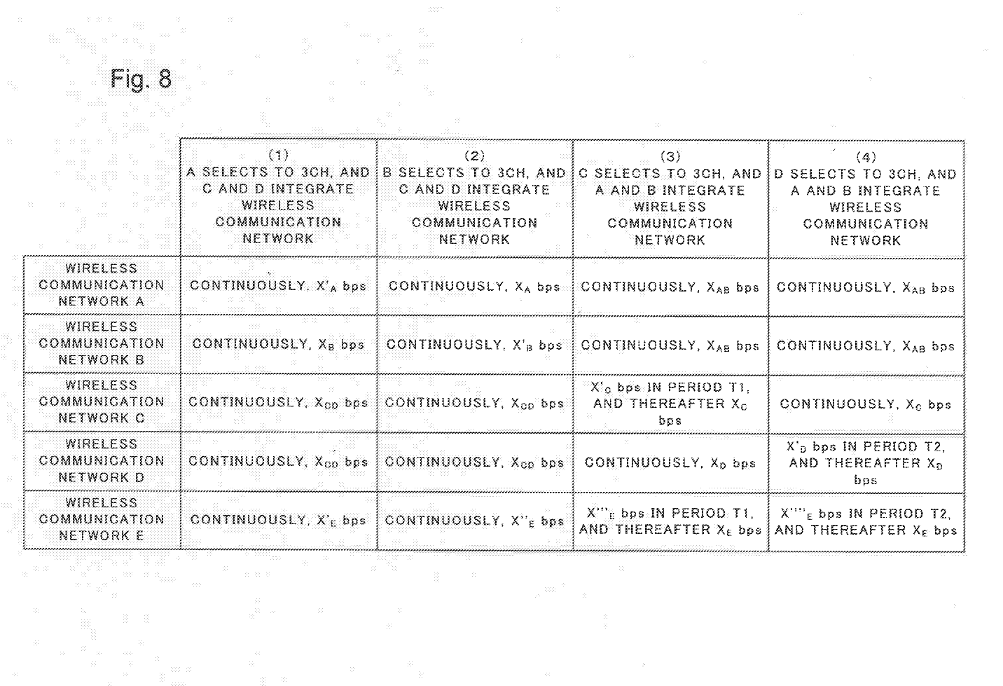

Here, the case where the interference avoidance processing of the four patterns illustrated in FIG. 8 are performed by each wireless communication network A to E will be described.

(1) A changes to 3 ch, and C and D integrate wireless communication network
(2) B changes to 3 ch, and C and D integrate wireless communication network
(3) C changes to 3 ch, and A and B integrate wireless communication network
(4) D changes to 3 ch, and A and B integrate wireless communication network

FIG. 8 is an explanatory diagram illustrating an example of estimation result of the communication quality of each wireless communication network according to the interference avoidance processing of each pattern. In the example illustrated in FIG. 8, Xᵢbps is the transmission rate when a wireless communication network i (i is any one of A to E) exclusively uses one channel. Xᵢⱼbps is the transmission rate when wireless communication network i (i is any one of A to E) and wireless communication network j (j is any one of A to E but is other than i) are integrated.

In the example illustrated in FIG. 8, X′ᵢbps is the transmission rate when the wireless communication network i (i is any one of A to E) performs communication while interfering with another wireless communication network. Therefore, Xᵢ>X′ᵢ. Note that F, in the example illustrated in FIG. 8, X′_{E}bps is the transmission rate of the wireless communication network E when the wireless communication network E interferes with the wireless communication network A. Also, X″_{E}bps is the transmission rate of the wireless communication network E when the wireless communication network E interferes with the wireless communication network B. Further, X″_{E}bps is the transmission rate of the wireless communication network E when the wireless communication network E interferes with the wireless communication network C. X″″_{E}bps is the transmission rate of wireless communication network E when wireless communication network E interferes with wireless communication network D.

In the case of the pattern of (1), B can continue to exclusively use 1 ch, and accordingly, communication can be continued at a high transmission rate continuously. Since A and E interfere with each other, the transmission rate decreases. As C and D increase the number of communication terminals sharing communication resources, the transmission rate decreases as compared with the case where one wireless communication network exclusively uses one channel. Note that if the number of communication terminals of C is denoted as N_{C} and the number of communication terminals of D is denoted as N_{C}, the transmission rate of C is simply represented by N_{C}/(N_{C}+N_{D}), for example. Further, the transmission rate of D is simply represented by N_{D}/(N_{C}+N_{D}), for example.

In the case of the pattern (2), A can continue to exclusively use 1 ch, and accordingly, communication can be continued at a high transmission rate continuously. Since B and E interfere with each other, the transmission rate decreases. Note that F, as illustrated in FIG. 7, the distance between B and E is shorter than the distance between A and E, and accordingly, the transmission rate of B and the transmission rate of E are affected by the influence of the interference and more greatly decrease than the transmission rate of A (X′_{A}bps) and the transmission rate of E (X′_{E}bps) in the case of (1). C and D are similar to the case of (1).

In the case of the pattern of (3), D can continue to exclusively use 2 ch, and therefore, communication can be continued with a high transmission rate continuously. Since C and E interfere with each other, the transmission rate decreases. However, as illustrated in FIG. 7, C is moving in a direction away from E, and accordingly, when a period T1 has elapsed and C and E move away from each other by such a distance that they do not interfere with each other, C and E can exclusively use 3 ch. Therefore, C and E will be able to communicate at a high transmission rate after the period T1 has elapsed.

In the case of the pattern of (4), C can continue to exclusively use 2 ch, and accordingly, C can continuously perform communication with a high transmission rate. Since D and E interfere with each other, the transmission rate is lowered. However, as illustrated in FIG. 7, D moves in a direction away from E, and accordingly, when a period T2 has elapsed and D and E move away from each other by such a distance that they do not interfere with each other, each of D and E will be able to exclusively use 3 ch. Therefore, when a period T2 has elapsed and D and E move away from each other by such a distance that they do not interfere with each other, D and E will be able to communicate with a high transmission rate. Note that, as illustrated in FIG. 7, D is initially closer to E than C, and accordingly, T2>T1 holds.

In the processing of step S404, the communication quality estimation unit 260 notifies the interference avoidance method determination unit 250 of the transmission rate of each wireless communication network as a result of the communication quality estimation processing, for example, for each pattern as described above. In accordance with the notification, the interference avoidance method determination unit 250 determines in accordance with which of the patterns the interference avoidance processing is to be executed.

Here, when the patterns (1) to (4) are compared, in the case where a period sufficiently longer than the periods T1 and T2 is considered, that is, when a period after the periods T1 and T2 is considered, the patterns (3) and (4) are preferable to the patterns of (1) and (2) because the number of wireless communication networks in which interference occurs is small.

When the pattern of (3) with the pattern of (4) are compared, as illustrated in FIG. 7, C is initially far from E rather than D, and accordingly, the influence of interference between C and E is considered to be smaller than the influence by interference between D and E. Therefore, in this example, it is assumed that the interference avoidance method determination unit of each communication terminal in each wireless communication network A to E determines to execute the processing corresponding to the pattern of (3).

Note that depending on the allocation of communication resources, for example, it is considered that the communication quality can be higher when A is changed to 2 ch and C is changed to 1 ch. Therefore, the interference avoidance method in the environment illustrated in FIG. 7 is not limited to the patterns (1) to (4) exemplified in FIG. 8 above.

Therefore, the interference avoidance method determination unit of the communication terminal of each of the wireless communication networks A to E determines to execute the interference avoidance processing corresponding to each pattern according to the setting previously made by the user, based on the estimation result of the communication quality notified by the communication quality estimation unit in the processing of step S404. Here, the setting made by the user in advance is, for example, setting to emphasizing the fairness of the wireless communication networks A to E or setting for making the communication quality of the wireless communication network of any of the wireless communication networks A to E higher than the communication quality of another wireless communication network

When the interference avoidance method determination unit 250 determines that the interference avoidance method determination unit 250 should perform the channel selection (Y in step S405), based on the estimation result of the communication quality notified by the communication quality estimation unit 260 in the processing of step S404, the interference avoidance method determination unit 250 notifies the channel selection unit 230 of the change destination channel and requests execution of channel selection (step S406). Then, the channel selection unit 130 executes the channel selection in the processing of the above-described step S308 to avoid interference.

Here, the reason why the interference avoidance method determination unit 250 of the communication terminal 200 notifies the channel selection unit 230 of the changed channel will be described. This is because, when the channel selection unit 230 estimates in the processing of step S404 that that overall communication quality of each wireless communication network is better when another wireless communication network uses one channel that the interference avoidance method determination unit 250 has notified, the channel selection unit 230 needs to select another channel different from the one channel.

In the case where the interference avoidance method determination unit 250 determines that network integration should be performed (Y in step S407), based on the estimation result of the communication quality notified by the processing at step S404, first, the interference avoidance method determination unit 250 checks whether or not an integration request has been received from another wireless communication network to network (step S408).

When the interference avoidance method determination unit 250 confirms that the network integration request has been received from another wireless communication network in the processing of step S408 (Y in step S408), the interference avoidance method determination unit 250 notifies, to the wireless communication network of the sender which has sent the network integration request, that the request has been accepted (step S409). Then, the interference avoidance method determination unit 250 requests execution of integration processing with the wireless communication network of the sender of the network integration request to the communication network integration unit 240 (step S410). Then, the communication network integration unit 240 executes the integration processing with the wireless communication network of the sender of the relevant network integration request in the processing of the above-described step S308 to avoid interference.

In the case where the interference avoidance method determination unit 150 confirms that the network integration request has not been received from another wireless communication network (N in step S408), the interference avoidance method determination unit 150 determines whether there is an integration-capable wireless communication network (step S411).

When the interference avoidance method determination unit 150 confirms that there is an integration-capable wireless communication network in the processing of step S411 (Y in step S411), the interference avoidance method determination unit 150 proceeds to the processing the processing of step S412, and otherwise (N in step S411), the processing of step S306 is terminated.

In step S412, the interference avoidance method determination unit 250 transmits, to the integration-capable wireless communication network, a network integration request for requesting the integration of the wireless communication network (step S412).

When the interference avoidance method determination unit 250 receives a response to the network integration request transmitted in the processing of step S412 (Y in step S413), the interference avoidance method determination unit 250 requests the communication network integration unit 240 to execute integration processing with the wireless communication network of the sender of the response (step S414). Then, the communication network integration unit 240 executes the integration processing with the wireless communication network of the sender of the response in the processing of the above-described step S308 to avoid interference.

Note that the interference avoidance method determination unit 250 repeats the retransmission of the network integration request in the case where response is not received even after a predetermined time has elapsed since sending the network integration request in the processing of step S412, for example.

Here, the reason why the interference avoidance method determination unit 250 of the communication terminal 200 informs the wireless communication network of the integration destination to the communication network integration unit 240 will be described. This is because, when the communication network integration unit 240 estimates in the processing of step S404 that that overall communication quality of each wireless communication network is better when one wireless communication network that the interference avoidance method determination unit 250 notifies is integrated with another wireless communication network, the communication network integration unit 240 needs to select another wireless communication network different from the one wireless communication network.

According to the present example embodiment, the interference avoidance method determination unit 250 determines the interference avoidance method in view of the interference avoidance processing by another wireless communication network.

Therefore, the communication terminal 200 can perform optimum interference avoidance processing for the entire communication system including another wireless communication network. Thus, in addition to the effect of the first example embodiment, the entire communication system including another wireless communication network can continue to obtain high communication quality.

More specifically, the interference avoidance processing is performed in accordance with, for example, setting to emphasizing the fairness of the wireless communication networks as or setting for making the communication quality of the wireless communication network of any of the wireless communication networks higher than the communication quality of another wireless communication network, which has been set by the user. Therefore, although each wireless communication network is autonomously distributed, it is possible to obtain communication performance conforming to the purpose and request of the user to be used.

### Third Example Embodiment

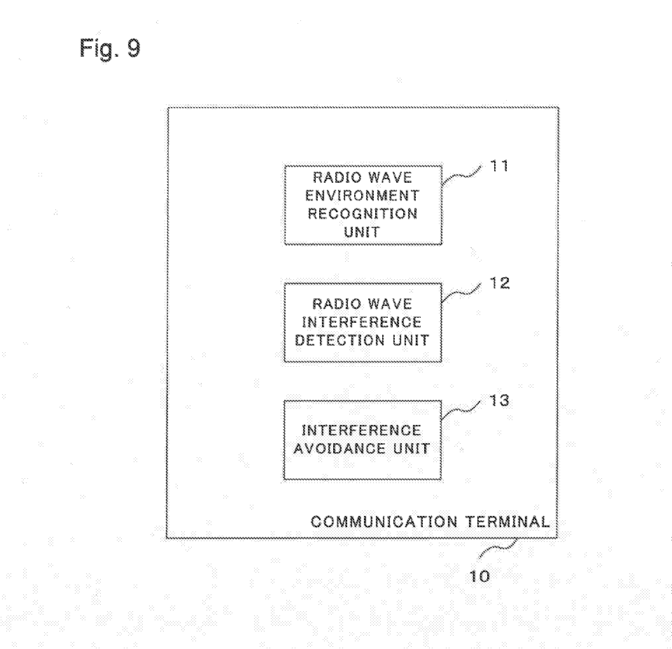

A communication terminal 10 of the third example embodiment of the present invention is described. FIG. 9 is a block diagram illustrating the configuration example of the communication terminal 10 of the third example embodiment of the present invention.

As illustrated in FIG. 9, the communication terminal 10 of the second example embodiment of the present invention includes a radio wave environment recognition unit 11, a radio wave interference detection unit 12, and an interference avoidance unit 13.

The radio wave environment recognition unit 11 corresponds to, for example, the radio wave environment recognition unit 110 in the first example embodiment illustrated in FIG. 1 and the radio wave environment recognition unit 210 in the second example embodiment illustrated in FIG. 4.

The radio wave interference detection unit 12 corresponds to the first example embodiment illustrated in FIG. 1 and the interference detection unit 120 in the second example embodiment illustrated in FIG. 4.

The interference avoidance unit 13 corresponds to the channel selection unit 130 and communication network integration unit 140 in the first example embodiment illustrated in FIG. 1 and the channel selection unit 230 and the communication network integration unit 240 in the second example embodiment illustrated in FIG. 4.

The radio wave environment recognition unit 11 recognizes the radio wave environment.

Also, the radio wave interference detection unit 12 detects radio wave interference between the wireless communication network to which it belongs and another wireless communication network.

Further, in the case where the radio wave interference detection unit 12 detects radio wave interference, the interference avoidance unit 13 executes interference avoidance processing to change the channel to be used, or integrate the wireless communication network to which it belongs with another wireless communication network, based on the radio wave environment recognized by the radio wave environment recognition unit 11.

According to the present example embodiment, in the case where the radio wave interference detection unit 12 detects the occurrence of interference with another wireless communication network, the interference avoidance unit 13 executes interference avoidance processing to change the channel to be used, or integrate the wireless communication network to which it belongs with another wireless communication network, based on the radio wave environment recognized by the radio wave environment recognition unit 11.

Therefore, high communication quality can be continuously obtained.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

This application is based upon and claims the benefit of priority from Japanese patent application No. 2016-62047, filed on Mar. 25, 2016, the disclosure of which is incorporated herein in its entirety by reference.

### REFERENCE SIGNS LIST

10 Communication terminal
11, 110, 210 Radio wave environment recognition unit
12 Radio wave interference detection unit
13 Interference avoidance unit
100, 200 Communication terminal
120 Interference detection unit
130, 230 Channel selection unit
140, 240 Communication network integration unit
150, 250 Interference avoidance method determination unit
260 Communication quality estimation unit

1. A communication terminal comprising:
a radio wave environment recognition unit recognizing radio wave environment;
a radio wave interference detection unit detecting radio wave interference between a wireless communication network to which the communication terminal belongs and another wireless communication network; and
an interference avoidance unit executing interference avoidance processing to change a channel to be used, or integrate the wireless communication network to which the communication terminal belongs with the another wireless communication network, based on the radio wave environment recognized by the radio wave environment recognition unit in a case where the radio wave interference detection unit detects the radio wave interference.

2. The communication terminal according to claim 1, wherein the radio wave environment recognition unit includes communication quality estimation unit for estimating communication quality of the wireless communication network to which the communication terminal belongs and a wireless communication network of a sender of a signal received by reception unit in the case where the interference avoidance unit executes the interference avoidance processing,
wherein the communication terminal further comprises interference avoidance processing determination unit determining content of the interference avoidance processing in accordance with an estimation result given by the communication quality estimation unit.

3. The communication terminal according to claim 2, wherein the communication quality estimation unit estimates communication quality of the wireless communication network to which the communication terminal belongs and the wireless communication network of the sender of the signal received by reception unit in the case where the interference avoidance unit and the wireless communication network of the sender of the signal received by reception unit execute the interference avoidance processing.

4. The communication terminal according to claim 1, comprising:
a channel identification unit identifying a channel that can be used upon change; and
an integration-destination identification unit identifying the another wireless communication network with which the wireless communication network to which the communication terminal belongs, can be integrated.

5. The communication terminal according to claim 1, wherein the interference avoidance unit executes interference avoidance processing for integration with the another wireless communication network in response to a request of the another wireless communication network.

6. A communication method comprising:
recognizing radio wave environment;
detecting radio wave interference between a wireless communication network to which the communication terminal belongs and another wireless communication network; and
executing interference avoidance processing to change a channel to be used, or integrate the wireless communication network to which the communication terminal belongs with the another wireless communication network, based on the recognized radio wave environment.

7. A storage medium storing a communication program causing a computer to execute:
radio wave environment recognition processing for recognizing radio wave environment;
radio wave interference detection processing for detecting radio wave interference between a wireless communication network to which the communication terminal belongs and another wireless communication network; and
interference avoidance processing for executing interference avoidance processing to change a channel to be used, or integrate the wireless communication network to which the communication terminal belongs with the another wireless communication network, based on the radio wave environment recognized by the radio wave environment recognition processing, in a case where the radio wave interference detection processing detects the radio wave interference.
